(19) United States
(12) Patent Application Publication
(10) Pub. No.: US 2021/0319685 A1
(43) Pub. Date: Oct. 14, 2021

(54) SUPPORT FOR DECKS OF BRIDGES, VIADUCTS AND THE LIKE

(71) Applicant: SAFECERTIFIEDSTRUCTURE TECNOLOGIA S.r.l., Roma (IT)

(72) Inventor: Giuseppe MANCINI, TORINO (IT)

(73) Assignee: SAFECERTIFIEDSTRUCTURE TECNOLOGIA S.r.l., Roma (IT)

(21) Appl. No.: 17/272,097

(22) PCT Filed: Aug. 28, 2019
(86) PCT No.: PCT/IB2019/057257

§ 371 Date: Feb. 26, 2021

(30) Foreign Application Priority Data
Aug. 31, 2018 (IT) 102018000008266

(51) Int. Cl. G08B 21/18; E01D 19/04

(52) U.S. Cl. CPC G08B 21/18; E01D 19/04

(57) ABSTRACT

Support for decks (3) of bridges, viaducts and the like, comprising a first and a second surface (6, 7), for the application and countering of a load, respectively, which can slide relatively and an anti-friction bearing (8) arranged between said surfaces (6, 7), the bearing (8) comprising at least one electrical contact (11) which is embedded therein at a predetermined distance from at least one of said opposing sides (9, 10) and can close or open an alarm circuit (15) as a result of predetermined wear and tear of said bearing (8).

The present invention relates to a support for decks of bridges, viaducts and the like, of the type comprising two surfaces, for the application and countering of a load, respectively, which can slide relatively and an anti-friction bearing arranged between said surfaces, it being possible to replace said bearing as a result of wear and tear that has a consequent reduction in thickness between opposing sides of the latter.

Within the specific technical context, it is known to produce supports which permit relative sliding between the part which is secured on the deck and the part which is secured on the top of the support pillars. These supports comprise a bearing made of resin with a low coefficient of friction (e.g. PTFE or the like) that is arranged between two plates which can slide relative to one another. Examples of this technology are described in US 2010195942, relating to sliding systems comprising polymer sheets, U.S. Pat. No. 6,289,640 which describes sliding systems with porous bearings filled with PTFE, US 2010095608 which uses PTFE coatings in the intermediate mobile parts, and KR101034176 which describes the use of PTFE between the sliding plates of a bridge. Finally, https://www.nap.edu/read/22479/chapter/11#188 presents a study on the wear and tear of different materials, including PTFE, intended for applications in bridges.

The PTFE bearings normally used in the supports typically have a thickness of approximately 9 mm.

When they become worn and reach a thickness of 6 mm, they should be changed; otherwise there is a risk that the PTFE bearings can escape from their receptacle, and that the two plates can come into direct contract. Inter alia, the wear and tear is not homogenous on the surface of the bearing.

The maintenance intervention which becomes necessary in this case is that of replacement of the bearings. Changing them involves raising the support by means of jacks so as to move the plates away and replace the worn bearings. Compared with the cost of the new bearing, the maintenance intervention in itself is an extremely significant factor.

Normally, the bearings are guaranteed for approximately 10 km of sliding, which is equivalent to approximately 20 years of service life. The maintenance is carried out periodically, with replacement of all the bearings, a certain amount of time in advance of the end of their effective service life, independently of their wear and tear. However, it is apparent that if it were possible to monitor the wear and tear of the bearings, and in this way extend their service life as far as the defined critical wear threshold, in many cases it would be possible to obtain a very substantial saving in the costs of maintenance of the structure.

The technical problem addressed by the present invention is that of providing a support for decks and a corresponding bearing, which are structurally and functionally designed to eliminate at least one of the disadvantages described with reference to the known prior art. This problem is solved by the invention by means of a support for decks according to claim 1, and a corresponding bearing according to claim 6. In particular, the fact of indicating the state of wear and tear of the bearing by means of an alarm circuit makes it possible to reduce the maintenance interventions, and extend the intervals between them, without detracting from the safety of the structure.

The use of two or more contacts embedded in the bearing at different depths according to claim 2 or 3 also makes it possible to diversify the alarm signals, for example with an initial alert state, followed by a request for intervention, and optionally also followed by an actual alarm signal.

The use of the plate connected to the deck as a fixed contact for the alarm system makes it possible to simplify the circuit structure of the bearing, in this case it being sufficient for the plate to be made at least partly of an electrically conductive material on which the alarm circuit closes when it comes into contact with the electrical contact embedded in the thickness of the bearing. U.S. Pat. No. 5,608,376 describes a system for monitoring the wear and tear of brake pads. The document illustrates a circuit diagram which is suitable for monitoring the support and the bearing according to this invention. However, no reference is made in this document to the possibility of using similar instruments to monitor the wear and tear of PTFE bearings in supports for decks of bridges, viaducts and the like.

The features and advantages of the invention will become more apparent from the detailed description of a preferred embodiment thereof, illustrated by way of non-limiting example, with reference to the appended drawings in which:

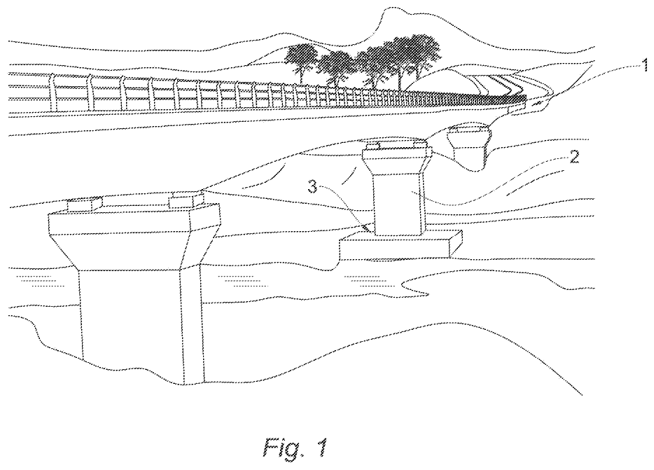

FIG. 1 is a perspective view of a bridge comprising a support for decks produced according to the present invention;

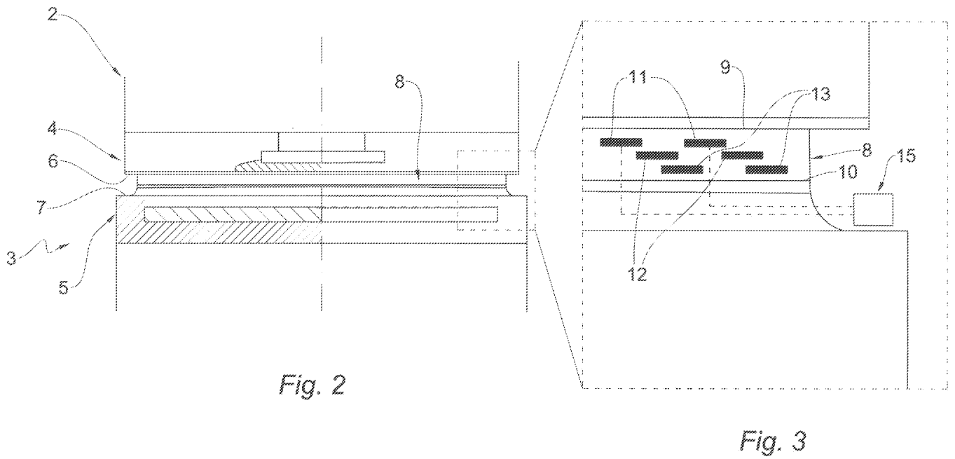

FIG. 2 is a schematic view of a cross section of a portion of the support in FIG. 1;

FIG. 3 is a detailed view of a portion of the cross section in FIG. 2;

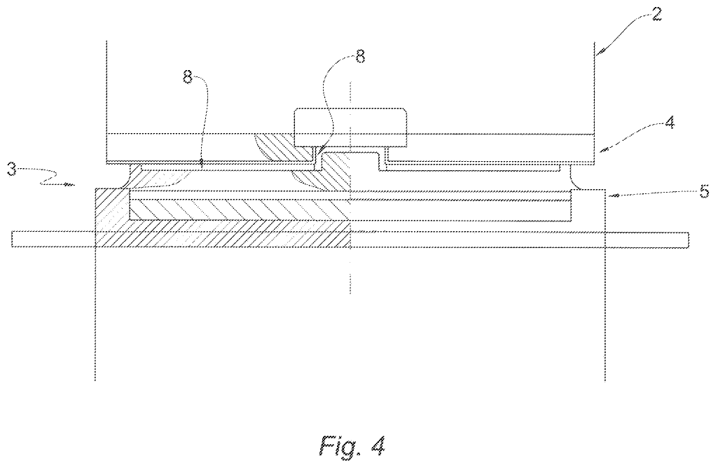

FIG. 4 is a further embodiment of the present invention in FIG. 1;

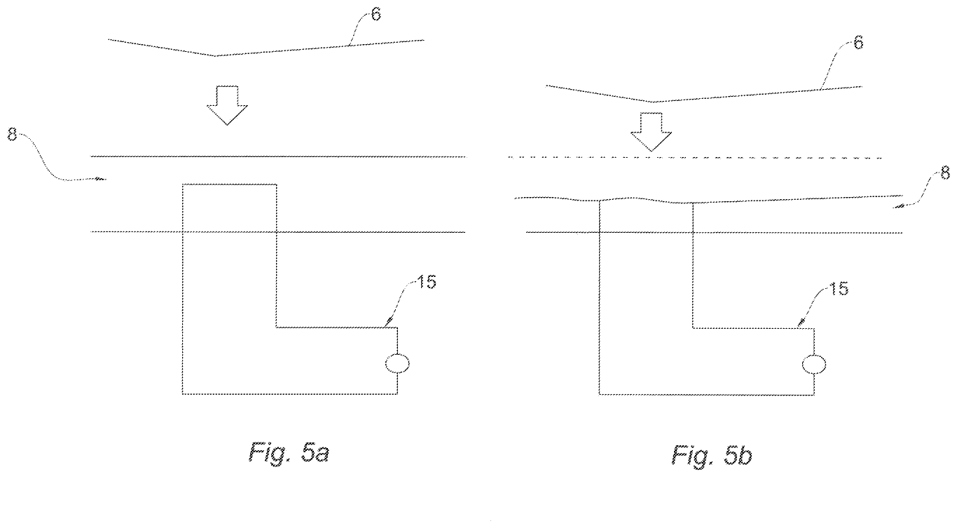

FIGS. 5a and 5b are detailed schematic views of a further embodiment of the present invention.

In the figures, 1 indicates as a whole a bridge deck supported on a pillar or another fixed structure 2 by means of a support indicated by 3 as a whole.

Preferably, the support 3 comprises a first and a second plate 4, 5 with respective facing surfaces 6, 7, respectively for application and countering of a load derived from the static and dynamic load conditions of the deck itself.

With reference to FIGS. 2, 3 and 4, the first plate 4 has a position higher than the second plate 5, since it is the one of the two which is further from the ground, and closer to the deck. Similarly, the second plate 5 has the lower position out of the two, since it is the one which is closer to the ground, and further from the deck.

Preferably, the first and second surfaces 6, 7 can slide relative to one another, and between them an anti-friction bearing 8 is arranged which reacts on the two surfaces 6, 7, keeping them spaced.

Preferably, the bearing 8 has a predetermined thickness when it is newly installed, and it can be replaced as a result of wear and tear that has a reduction in the thickness between its opposing sides 9, 10 as the result of relative sliding between them and, for example, the surface of application of the load 6. On the other hand, in this configuration, by way of example, the bearing 8 is stationary relative to the surface 7 of countering of the load of the deck 1.

It will be appreciated that the inverse situation is also advantageously possible, with the bearing 8 integral with the surface 6, and mobile relative to the surface 7, and it is also possible for the bearing 8 to be mobile relative to both of said surfaces, although the first condition indicated is the one which is preferred.

As a result of its wear and tear, over a period of time the bearing 8 is subject to a reduction of thickness between its opposing sides 9, 10. The wear and tear can be homogenous on the sliding surface, or non-homogenous. In all cases, it gives rise to a reduction of thickness which can be acceptable within predetermined limits. For example, a PTFE (polytetrafluoroethylene) bearing with an initial thickness of approximately 9 mm can be used safely down to a minimum thickness of 6 mm. A reduction of thickness beyond this threshold involves the risk, for example, of the bearing becoming deformed, and also exiting from its seat, and in this way causing direct contact between the plates which does not comply with the required safety conditions for the deck. Thus, when the minimum permissible thickness is reached, the bearing must be replaced.

The replacement operation, which in itself is very onerous, involves raising the deck from the pillar by means of jacks, removing the worn bearing, and inserting a new bearing. At present the manufacturers suggest safe use of the PTFE bearings up to a maximum relative sliding, i.e. the algebraic sum of all the slidings performed, of approximately 10 km, which, it is estimated, is reached in approximately 20 years of service life of the bridge. Taking into account a total service life of the structure calculated as approximately 100 years, at least 4 replacements of bearings must be planned during this period.

Preferably, the first plate 4 is connected to the structure 2 by means of blocking elements, for example by means of a pin 16 as shown in FIGS. 2 and 4.

According to one embodiment, the second plate 5 is connected to the structure 2 by means of adhesion and/or anchorage, which is provided for example by means of pins and/or anchorage legs inserted in the structure 2.

Advantageously, the bearing 8 is accommodated inside a seat 19, which, with reference to FIGS. 2 and 4 for example, is provided in the second plate 5. According to one embodiment, in its interior the seat 19 comprises a resilient disc, which is advantageously made of rubber, arranged between the base of said seat 19 and the bearing 8.

Preferably, a polymer shell 21 is positioned around the bearing 8, which shell can protect the bearing 8 against dust.

According to the present invention, at least one electrical contact 11 is embedded in the thickness of the bearing 8, preferably a plurality of electrical contacts 11 which are originally placed at a predetermined distance from at least one of the opposing sides 9, 10 of the bearing 8, and said contact can close or open an alarm circuit 15 as a result of predetermined wear and tear of said bearing 8. For example, a first plurality of contacts 11 are preferably distributed in the bearing 8 at a depth of 2 mm from the side 9 which is subject to wear and tear, when the bearing 8 is fitted in a stationary manner on the first upper plate 4 which can slide relative to the second lower plate 5. It will be appreciated that it is also appropriate to take into consideration the technical solution wherein the bearing 8 is fitted in a stationary manner and is integral on the second lower plate 5 which can slide relative to the first upper plate 4 (see FIGS. 2, 3 and 4)

Preferably, a second plurality of electrical contacts 12 are embedded in the bearing 8 at a depth, relative to the preceding reference, of 2.5 mm. More preferably, finally, a third plurality of electrical contacts 13 are embedded in the bearing 8 at a depth of 3 mm relative to the same reference.

Thus, according to one embodiment, at least three electrical contacts 11, 12, 13 are embedded in the bearing 8 at different distances from at least one of the opposing sides 9, 10, in order to close or open the alarm circuit 15 as a result of predetermined different wear conditions of the bearing 8.

By this means, as a result of the gradual wear and tear of the bearing 8, firstly the electrical contacts 11 will be exposed, then the electrical contacts 12, and finally the electrical contacts 13, indicating respectively a first, a second and a third level of alert which make it possible to intervene in good time for the planned replacement of the bearing.

Advantageously, in the case of particularly significant local wear and tear, it will be possible that the bearing 8 is worn irregularly at some points, and that the circuit is closed, for example, between an electrical contact of the first plurality of electrical contacts 11 and an electrical contact of the second and/or third plurality of electrical contacts 12, 13. Preferably, the electrical contacts 11-13 are closed for example on the surface of the second lower plate 5 which, since it is electrically conductive at least locally, will close (or open) an alarm circuit 15.

In the case in which the bearing 8 is integrally connected to the second lower plate 5, the electrical contacts 11-13 are preferably closed on an electrically conductive surface of the first upper plate 4.

As previously described, it is understood that each plurality of electrical contacts 11-13 also makes it possible to determine abnormal wear and tear of the bearing 8 comprising localised wear and tear.

According to one embodiment, at least three series of powered wires are embedded at different points of the bearing 8 and/or at different distances from the face of the bearing that is subject to wear and tear such that, when said powered wires are short-circuited with an electric conductor plate applied to the support, an alarm signal is activated for a first attention threshold, as well as a second alarm signal, and a third end of life signal, respectively for a first, a second and a third reduction in thickness of the bearing 8.

In this context, the term “powered wires” indicates electrical terminals which are connected (or connectable) to a voltage generator, so as to be able to be energised once current is passing in the circuit, in other words once the circuit to which they belong is closed.

According to another embodiment and with reference to FIG. 5a, the electrical contacts and/or the powered wires embedded in the bearing 8 can form an electric circuit which is normally closed. By way of example, FIG. 5a represents an electric circuit which is normally closed, comprising said powered wires which are connected to a voltage generator. This circuit preferably also comprises the alarm circuit 15.

In this case, as a result of the friction applied to the bearing 8, the thickness thereof is progressively reduced until the wear and tear reaches and affects said electrical contacts and/or the powered wires, thus interrupting them (for example removing entire sections of them, see FIG. 5b), and thus opening the electric circuit which is normally closed.

At this point, this variation of the circuit can easily be detected, and a corresponding alarm signal is emitted. In FIG. 5b, the initial thickness of the bearing 8 is indicated by a broken line, while the final thickness, produced as a result of the wear and tear caused by the first surface 6 of application of the load, is represented by a continuous line.

Advantageously, this alarm signal according to predetermined wear and tear of the bearing and a corresponding reduction of the bearing itself is transmitted by a processing unit which is operatively connected to the electrical circuit comprising the electrical contacts and/or the powered wires.

In this last configuration, therefore, the presence of the electric conductor plate applied to the support is not necessary.

According to one embodiment, the bearing 8 is in sliding contact with at least one of the surfaces 6, 7, which surface comprises an auxiliary electrical contact cooperating with said at least one electrical contact 11 in the bearing 8 in order to close or open the alarm circuit 15.

According to another embodiment, the second lower plate 5 comprises a guide 16 which projects towards the first upper plate 4 and preferably extends in the radial direction relative to the centre of the second lower plate 5.

The bearing 8 preferably comprises a lateral portion 8a which extends to at least partly cover lateral portions of said guide 16. Advantageously, a fourth plurality of electrical contacts 14 are embedded in this lateral portion 8a of the bearing 8. It is found that if the displacements, and thus the wear and tear, involve wear of the bearing 8 so as to bring at least one of the electrical contacts of the fourth plurality of electrical contacts 14 into contact with a part of the electric conductor plate, the condition would be created for opening or closing said electric circuit, and thus activating the alarm circuit 15.

With reference to FIG. 4, the guide 16 has a substantially parallelepiped form, with its main axis of extension parallel to a radial direction of the first or second plate 4, 5.

Advantageously, the guide 16 extends for almost all the entire radial length of the second lower plate 5.

As shown by FIG. 4 and according to one embodiment, the first upper plate 4 comprises a recess 17 which is shaped so as to be able to accommodate the guide 16 at least partly in its interior.

Preferably, in this configuration, the electric conductor plate is contained in the first upper side 4 and has a shape that follows the extension of the first upper side 4, and therefore also of said recess 17.

By this means, when wear and tear takes place as a result of relative displacement of the lateral portion 8a of the bearing 8, so as to bring at least one of the electrical contacts of the fourth plurality into contact with the electric conductor plate of the first upper side 4, the alarm circuit 15 is closed or opened, and the predetermined alarm signal is transmitted.

In accordance with the preceding description, the bearing 8 can advantageously comprise powered wires embedded in the lateral portion 8a which form an electric circuit which is normally closed, and which becomes open when at least one powered wire is interrupted as a result of wear and tear of the bearing 8.

In this context, this configuration of the support for decks comprising the guide 16 is defined as “two-way”, whereas the embodiment previously described without the guide 16 is defined as “one-way”.

The one-way system makes it possible to detect a difference between the wear and tear of the two parts in relative motion, which will indicate any irregularities of pressure relative to a direction transverse to the movement permitted.

It is important to note that, when the support system 3 is two-way, any abnormalities of behaviour and assembly can be indicated, not just in the direction transverse to the movement permitted, but in any direction.

The present invention claims an anti-friction bearing 8 for supports for decks, at least partly having the features previously described, which bearing is designed to be arranged so as to be replaceable as a result of wear and tear that has a consequent reduction in thickness between opposing sides thereof, between the first and the second surfaces 6, 7 of the support, for the application and countering of a load, respectively, which surfaces can slide relatively.

Preferably, the bearing 8 comprises at least one electrical contact 11 which is embedded in the thickness of the bearing 8 at a predetermined distance from at least one of the opposing sides 9, 10, and can close or open an alarm circuit 15 as a result of predetermined wear and tear of the bearing 8.

Similar arguments presented for the bearing 8 included in a support for decks 3 apply in this context to the features relating to the bearing 8.

According to one embodiment, at least two electrical contacts 11, 12 are embedded in the anti-friction bearing 8 at different distances from at least one of the opposing sides 9, 10, in order to close or open the alarm circuit 15 as a result of predetermined different wear conditions of the bearing 8.

Preferably, at least three electrical contacts 11, 12, 13 are embedded in the anti-friction bearing 8 at different distances from at least one of the opposing sides 9, 10, in order to close or open the alarm circuit 15 as a result of predetermined different wear conditions of the bearing 8.

Preferably, an alarm signal is activated for a first attention threshold, as well as a second alarm signal and a third end of life signal, respectively for a first, a second and a third reduction in thickness of the bearing.

According to one embodiment, the anti-friction bearing 8 is in sliding contact with at least one of the surfaces 6, 7, which surface comprises an auxiliary electrical contact cooperating with the at least one electrical contact 11 in the bearing 8, in order to close or open said alarm circuit 15.

Advantageously, powered wires are embedded in the bearing 8, which wires have different positions with respect to the thickness of the bearing 8.

For example, powered wires are embedded in the anti-friction bearing 8 that have different heights (e.g. 7/6.2/6 mm) at different points of the bearing 8 such that, when the powered wires close a circuit by means of contact with an upper plate, an alarm signal is activated for a first attention threshold, as well as a second alarm signal, and a third end of life signal, respectively for a first height of said powered wires, a second height of said powered wires, and a third height of said powered wires.

The invention thus solves the problem described, and achieves numerous advantages, including the indication of lack of parallelism between the plates as a result of assembly errors, abnormal wear and tear caused by instability of the span above, caused by rotations which are incompatible with the dimensions of the support, and consequent lack of uniformity of the pressure applied.

1. Support for decks (3) of bridges, viaducts and other overpasses comprising a first and a second surface (6, 7), for application and countering of a load, respectively, which can slide relatively and an anti-friction bearing (8) arranged between said first and second surfaces (6, 7), it being possible to replace said bearing (8) as a result of wear and tear that has a consequent reduction in thickness between opposing sides (9, 10) of the latter, comprising at least one electrical contact (11) which is embedded in a thickness of said bearing (8) at a predetermined distance from at least one of said opposing sides (9, 10) and can close or open an alarm circuit (15) as a result of predetermined wear and tear of said bearing (8).

2. The support for decks (3) according to claim 1, wherein at least two electrical contacts (11, 12) are embedded in said bearing (8) at different distances from at least one of said opposing sides (9, 10) to close or open said alarm circuit (15) as a result of predetermined different wear conditions of said bearing (8).

3. The support for decks (3) according to claim 1, wherein at least three electrical contacts (11, 12, 13) are embedded in the bearing (8) at different distances from at least one of said opposing sides (9, 10) to close or open said alarm circuit (15) as a result of predetermined different wear conditions of said bearing (8).

4. The support for decks (3) according to claim 1 wherein said bearing (8) is in sliding contact with at least one of said first and second surfaces (6, 7), said surface comprises an auxiliary electrical contact cooperating with said at least one electrical contact (11) in the bearing (8) to close or open said alarm circuit (15).

5. The support for decks (3) according to claim 1, wherein at least three series of powered wires are embedded at different points on said bearing (8) and/or at different distances from the face of the bearing (8) subject to wear and tear such that when said powered wires are short-circuited with an electric conductor plate applied to the support (3), an alarm signal is activated for a first attention threshold, a second alarm signal and a third end of life signal for a first, a second and a third reduction in thickness of the bearing, respectively.

6. Anti-friction bearing (8) for supports for decks according to claim 1 suitable for being arranged so as to be replaceable as a result of wear and tear that has a consequent reduction in thickness between opposing sides of the latter, between a first and a second surface (6, 7) of said support, for the application and countering of a load, respectively, that can slide relatively, the bearing comprising at least one electrical contact (11) which is embedded in the thickness of said bearing (8) at a predetermined distance from at least one of the opposing sides (9, 10) of said bearing (8) and can close or open an alarm circuit (15) as a result of predetermined wear and tear of said bearing (8).

7. The anti-friction bearing (8) according to claim 6, wherein at least two electrical contacts (11, 12) are embedded at different distances from at least one of said opposing sides (9, 10) to close or open said alarm circuit (15) as a result of predetermined different wear conditions of said bearing (8).

8. The anti-friction bearing (8) according to claim 6, wherein at least three electrical contacts (11, 12, 13) are embedded at different distances from at least one of said opposing sides (9, 10) to close or open said alarm circuit (15) as a result of predetermined different wear conditions of said bearing (8).

9. The anti-friction bearing (8) according to claim 6, wherein powered wires are embedded in said bearing (8) that have different positions with respect to the thickness of said bearing.
